(19) United States
(12) Patent Application Publication
(10) Pub. No.: US 2026/0188284 A1
(43) Pub. Date: Jul. 2, 2026

(54) Stringed Musical Instruments and Methods of Making and Using Stringed Musical Instruments

(71) Applicant: David Eugene Renshaw, Bonaire, GA (US)

(72) Inventor: David Eugene Renshaw, Bonaire, GA (US)

(21) Appl. No.: 19/198,086

(22) Filed: May 4, 2025

Related U.S. Application Data
(60) Provisional application No. 63/642,921, filed on May 6, 2024.

(51) Int. Cl. G10D 1/08; G10D 3/06; G10D 3/12

(52) U.S. Cl. CPC G10D 1/08; G10D 3/06; G10D 3/12

(57) ABSTRACT

Stringed musical instruments are disclosed. Methods of making and using stringed musical instruments are also disclosed.

### CROSS-REFERENCE TO RELATED APPLICATIONS

This patent application claims the benefit of priority to U.S. Provisional Patent Application Ser. No. 63/642,921 filed on May 6, 2024 entitled “STRINGED MUSICAL INSTRUMENTS AND METHODS OF MAKING AND USING STRINGED MUSICAL INSTRUMENTS,” the subject matter of which is hereby incorporated by reference in its entirety.

### FIELD OF THE INVENTION

The present invention relates to stringed musical instruments and methods of using stringed musical instruments.

### BACKGROUND OF THE INVENTION

There is a need in the art for improved stringed musical instruments that enable training on a stringed musical instrument, and ease of use of a given stringed musical instrument.

### SUMMARY OF THE INVENTION

The present invention is directed to stringed musical instruments. In some embodiments, the stringed musical instrument comprises an instrument body; a neck extending from the instrument body; strings extending from the instrument body, and along the neck, each string being connected to (i) an instrument body string anchor and (ii) a neck anchor proximate a neck end opposite the instrument body; and one or more fret boards, each fret board being attachable to and detachable from the neck of the stringed musical instrument. The stringed musical instrument may comprise one or more fret boards wherein each fret board has a fret configuration for a specific musical key.

In some embodiments, the stringed musical instrument comprises an instrument body; a neck extending from the instrument body; strings extending from the instrument body, and along the neck, each string being connected to (i) an instrument body string anchor and (ii) a neck anchor proximate a neck end opposite the instrument body; and a fret board along the neck of the stringed musical instrument, the fret board having a fret configuration for a specific musical key.

The present invention is further directed to fret packages comprising sets of partial frets and/or attachable/detachable frets, wherein the set of partial frets or attachable/detachable frets (i) is attachable to and detachable from a fret board or a fret board lodging location of a stringed musical instrument, and (ii) when assembled on the stringed musical instrument, provide a fret configuration for a specific musical key. A given fret package (or set of partial frets and/or attachable/detachable frets) may comprise one or more partial frets and/or attachable/detachable frets (e.g., from one to 18 partial frets and/or attachable/detachable frets) that are connectable/attachable to the stringed musical instrument, for example, by sliding the one or more partial frets and/or attachable/detachable frets into fret slots or grooves along a neck portion (or a fret board lodging location) of the stringed musical instrument. The positioned frets may either be flush within the resulting fret board or be elevated under each string so that each elevated position is a note in the desired key (e.g., the key of “C”). For example, one could use a fret package (or set) of one or more partial frets and/or attachable/detachable frets for the key of C, another fret package (or set) of one or more partial frets and/or attachable/detachable frets for the key of G, etc.

The present invention is even further directed to methods for making a musical instrument. In some embodiments, the method for making a musical instrument comprises: (a) forming an instrument body with (i) a neck extending from the instrument body, (ii) an instrument body string anchor proximate one end of the instrument body opposite the neck, and (iii) a neck anchor proximate a neck end opposite the instrument body; and (b) forming one or more fret boards, each fret board being attachable to and detachable from the neck of the stringed musical instrument. The step of forming one or more fret boards may further comprise forming each fret board and/or each attachable/detachable fret so as to have a fret configuration along the fret board for a specific musical key.

In some embodiments, the method for making a musical instrument comprises: (a) forming an instrument body with (i) a neck extending from the instrument body, (ii) an instrument body string anchor proximate one end of the instrument body opposite the neck, and (iii) a neck anchor proximate a neck end opposite the instrument body; and (b) forming a fret board that has a fret configuration along the fret board for a specific musical key.

The present invention is even further directed to a set of fret boards for a stringed musical instrument, wherein the set of fret boards comprises one or more fret boards, wherein each fret board has a fret configuration for a specific musical key. In some embodiments, the set of fret boards comprises one or more fret boards having a specific musical key selected from any one of major keys or minor keys or configurations representing specific scales.

The present invention is even further directed to kits for making a stringed musical instrument, wherein the kit comprising (a) a stringed musical instrument that has a removable and/or modified fret board, (b) one or more fret boards that are each independently attachable to and detachable from a neck of the stringed musical instrument, and/or (c) one or more attachable/detachable frets that are each independently attachable to and detachable from the removable and/or modified fret board of the stringed musical instrument.

These and other features and advantages of the present invention will become apparent after a review of the following detailed description of the disclosed embodiments and the appended claims.

### BRIEF DESCRIPTION OF THE FIGURES

The present invention is further described with reference to the appended figure, wherein:

FIG. 1 depicts an exemplary stringed musical instrument of the present invention;

FIG. 2 depicts a cross-sectional view of the exemplary stringed musical instrument shown in FIG. 1 as viewed along line 2-2 shown in FIG. 1;

FIGS. 3A-3C depict exemplary fret boards of the present invention;

FIGS. 4A-4D depict views of exemplary fret board connecting members that are suitable for use on the fret boards of the present invention to enable attachment of the fret board to a stringed musical instrument of the present invention;

FIGS. 5A-5D depict views of exemplary stringed musical instrument connecting members that are suitable for use on the stringed musical instruments of the present invention to enable attachment of an attachable/detachable fret board to the stringed musical instrument;

FIG. 6A depicts a close-up view of the circled portion of exemplary fret board shown in FIG. 3B, the circled portion being labeled FIG. 6A as shown in FIG. 3B;

FIG. 6B₁-6B₄ depict cross-sectional views of exemplary fret grooves within the exemplary fret board shown in FIGS. 3B and 6A as viewed along line 6B_{X}-6B_{X} shown in FIG. 6A;

FIG. 6C₁-6C₄ depict cross-sectional views of exemplary frets while positioned within exemplary fret grooves of the exemplary fret board shown in FIGS. 3B and 6A as viewed along line 6C_{X}-6C_{X} shown in FIG. 6A; and

FIG. 7 depicts a side view of an exemplary attachable/detachable fret of the present invention.

The features of the present musical instruments, and methods are set forth in part in the following preferred embodiments. This overview is intended to provide nonlimiting descriptions of the present subject matter and is not intended to provide an exclusive or exhaustive explanation. The preferred embodiments below provide further information about the s, and methods of the present invention as described herein.

### DETAILED DESCRIPTION OF THE INVENTION

The present invention is directed to stringed musical instruments. The present invention is further directed to methods of making stringed musical instruments. The present invention is even further directed to methods of using stringed musical instruments.

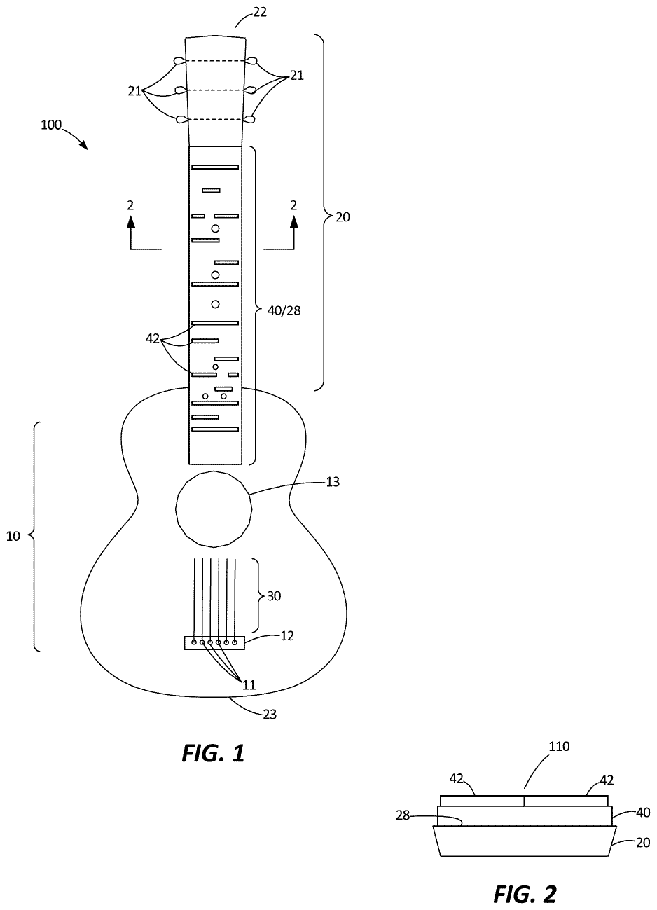

FIGS. 1-3C provide examples of exemplary stringed musical instruments 100, and exemplary fret boards 40. As shown in FIG. 1, exemplary stringed musical instrument 100 comprises: an instrument body 10; a neck 20 extending from the instrument body 10; strings 30 extending from the instrument body 10, and along the neck 20, each string 30 being connected to (i) an instrument body string anchor 11 and (ii) a neck anchor 21 proximate a neck end 22 opposite the instrument body 10; and one or more fret boards 40. As discussed herein, in some embodiments, a given fret board 40 is attachable to and detachable from the neck 20 of the stringed musical instrument 100. See, for example, exemplary stringed musical instrument 100 in FIG. 1, wherein partial strings 30 are shown so that more details of fret board 40 are better shown.

As further shown in FIG. 1, exemplary instrument body 10 has a sound hole 13 therein. Exemplary stringed musical instrument 100 also comprises (i) six instrument body string anchors 11 positioned along a bridge 12 that is attached to exemplary instrument body 10, and (ii) six neck anchors 21 proximate neck end 22. Typically, the number of instrument body string anchors 11, and the number of neck anchors 21 corresponds to the number of strings 30 used on the stringed musical instrument 100, for example, a guitar, a mandolin, a ukelele, or any other stringed musical instrument.

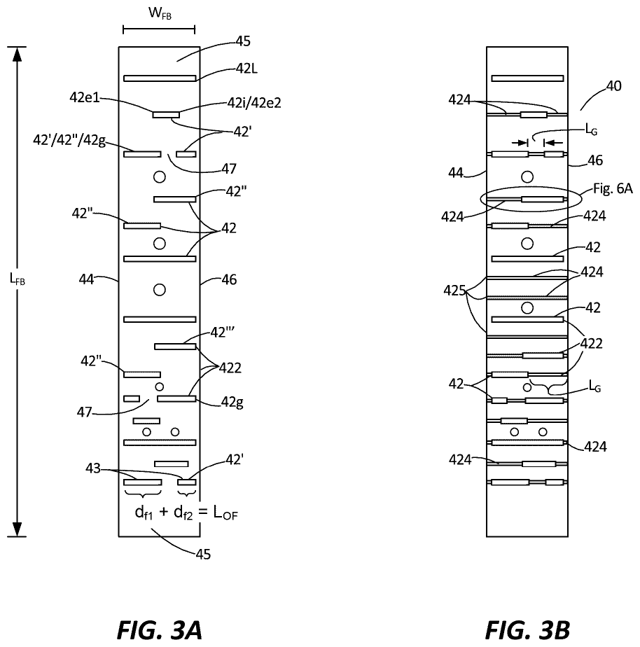

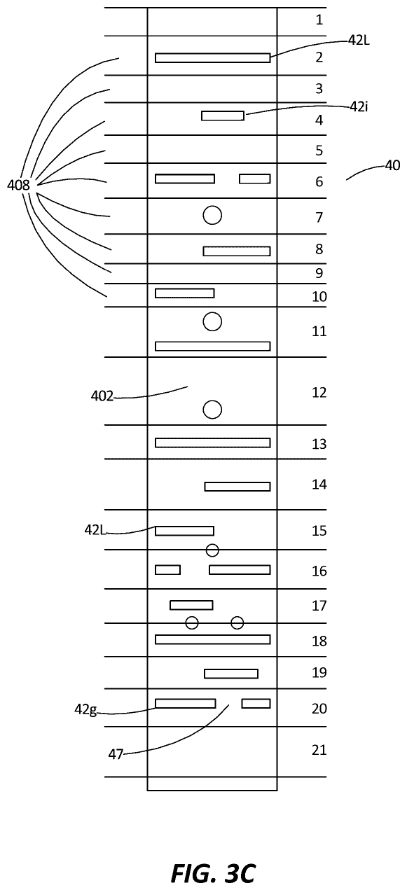

FIGS. 3A-3C depict exemplary fret boards of the present invention. FIG. 3A shows an exemplary fret board 40 comprising a single fret board 40 with numerous fixed frets 42 thereon (i.e., fixed frets 42 are not removable from fret 40). FIG. 3B shows an exemplary fret board 40 comprising a single fret board 40 with numerous attachable/detachable frets 42 thereon (i.e., attachable/detachable frets 42 are removable from fret 40). FIG. 3C shows an exemplary fret board 40 comprising twenty-one combined fret boards 40 with and without frets 42 thereon.

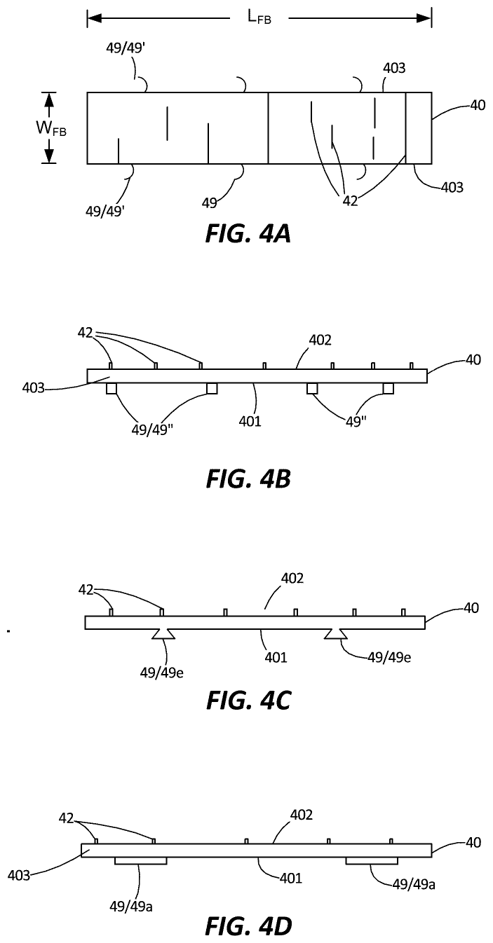

FIGS. 4A-4D depict various views of exemplary fret board connecting members 49 of removable/attachable fret boards 40 of the present invention. Exemplary fret board connecting members 49 enable attachment of a given fret board 40 to a stringed musical instrument 100 of the present invention. As shown in FIGS. 4A-4D, removable/attachable fret boards 40 of the present invention may comprise various types and shapes of fret board connecting members 49.

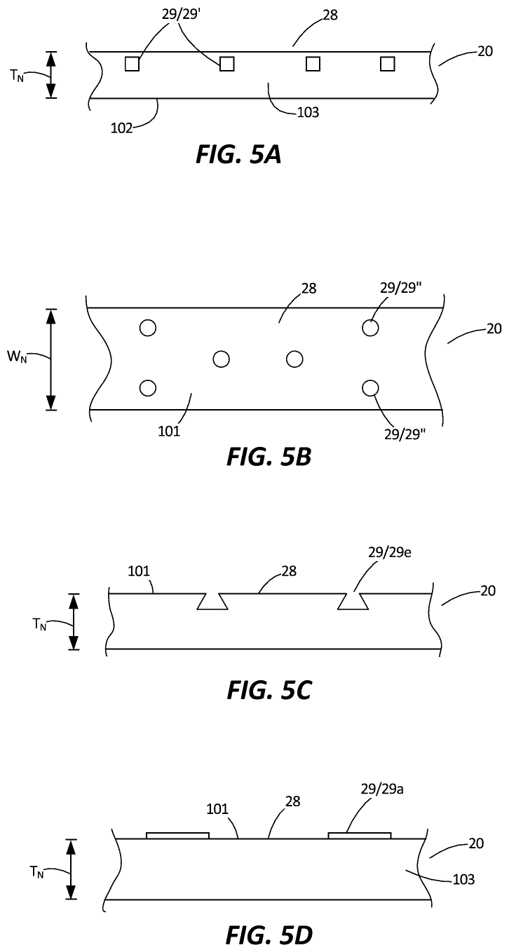

FIGS. 5A-5D depict views of exemplary stringed musical instrument connecting members 29 that are suitable for use on stringed musical instruments 100 of the present invention to enable attachment of an attachable/detachable fret board 40 to the stringed musical instrument 100.

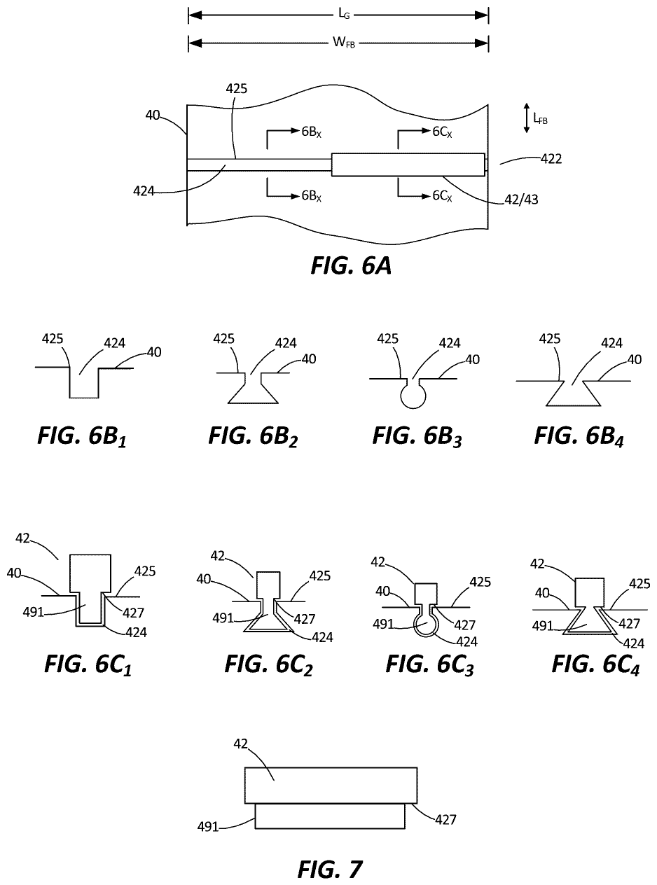

FIG. 6A depicts a close-up view of the circled portion of exemplary fret board 40 shown in FIG. 3B, the circled portion being labeled FIG. 6A as shown in FIG. 3B. As shown in FIG. 6A, an exemplary fret groove 424 having a groove length L_{G} extends across a width W_{FB} of fret board 40. An exemplary attachable/detachable fret 42 is positioned within a right-hand side of exemplary fret groove 424.

FIG. 6B₁-6B₄ depict cross-sectional views of exemplary fret grooves 424 within the exemplary fret board 40 shown in FIGS. 3B and 6A as viewed along line 6B_{X}-6B_{X} shown in FIG. 6A. As shown in 6B₁-6B₄, a given fret groove 424 may have a variety of groove channel configurations.

FIG. 6C₁-6C₄ depict cross-sectional views of exemplary attachable/detachable frets 42 while positioned within exemplary fret grooves 424 of the exemplary fret board 40 shown in FIGS. 3B and 6A as viewed along line 6C_{X}-6C_{X} shown in FIG. 6A. As shown in 6C₁-6C₄, a given attachable/detachable fret 42 may have a variety of fret connecting member cross-sectional configurations that closely match a corresponding cross-sectional configuration of a matching fret groove 424.

FIG. 7 depicts a side view of an exemplary attachable/detachable fret 42 of the present invention. As shown in FIG. 7, a given attachable/detachable fret 42 may have a variety of fret connecting member cross-sectional configurations.

The present invention is described above and further illustrated below by way of additional embodiments, and examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Additional Embodiments

### Stringed Musical Instrument Embodiments

1. A stringed musical instrument 100 comprising: an instrument body 10; a neck 2 extending from the instrument body 10; strings 30 extending from the instrument body 10, and along the neck 20, each string 30 being connected to (i) an instrument body string anchor 11 and (ii) a neck anchor 21 proximate a neck end 22 opposite the instrument body 10; and one or more fret boards 40, each fret board 40 being attachable to and detachable from the neck 20 of the stringed musical instrument 100. See, for example, exemplary stringed musical instrument 100 in FIG. 1.

2. The stringed musical instrument 100 of embodiment 1, wherein each fret board 40 has a fret 42 configuration for a specific musical key, a set of scales, or other desired configuration.

3. A stringed musical instrument 100 comprising: an instrument body 10; a neck 2 extending from the instrument body 10; strings 30 extending from the instrument body 10, and along the neck 20, each string 30 being connected to (i) an instrument body string anchor 11 and (ii) a neck anchor 21 proximate a neck end 22 opposite the instrument body 10; and a fret board 40 along the neck 20 of the stringed musical instrument 100, the fret board 40 having a fret 42 configuration for a specific musical key. See again, for example, exemplary stringed musical instrument 100 in FIG. 1.

4. The stringed musical instrument 100 of embodiment 3, wherein the fret board 40 is attachable to and detachable from the neck 20 of the stringed musical instrument 100.

5. The stringed musical instrument 100 of embodiment 4, wherein the fret board 40 is one fret board 40 within a set of one or more fret boards 40, each fret board 40 being attachable to and detachable from the neck 20 of the stringed musical instrument 100.

6. The stringed musical instrument 100 of any one of embodiments 1 to 5, wherein each fret board 40 has a fret 42 configuration for a specific musical key, and the specific musical key is selected from any one of major keys or minor keys or configuration of scales.

7. The stringed musical instrument 100 of any one of embodiments 2 to 6, wherein the specific musical key is selected from the key of “A”, the key of “B”, the key of “C”, the key of “D”, the key of “E”, or the key of “F”.

8. The stringed musical instrument 100 of any one of embodiments 2 to 7, wherein the specific musical key is selected from the key of “A flat”, the key of “B flat”, the key of “D flat”, the key of “E flat”, the key of “G flat”, the key of “A sharp”, the key of “C sharp”, the key of “D sharp”, the key of “F sharp”, or the key of “G sharp”.

9. The stringed musical instrument 100 of any one of embodiments 2 to 6, wherein the specific musical key is selected for a specific configuration of scales or other desired configuration.

10. The stringed musical instrument 100 of any one of embodiments 1 to 2 and 5 to 9, wherein said one or more fret boards 40 comprises a single fret board 40.

11. The stringed musical instrument 100 of any one of embodiments 1 to 2 and 5 to 9, wherein said one or more fret boards 40 comprises two or more fret boards 40.

12. The stringed musical instrument 100 of any one of embodiments 1 to 2, 5 to 9, and 11, wherein said one or more fret boards 40 comprises from about three fret boards 40 to about 18 fret boards 40.

13. The stringed musical instrument 100 of any one of embodiments 1 to 12, wherein each fret board 40 comprises a plurality of frets 42 extending across a width W_{FB} of the fret board along a length L_{FB} of the fret board, wherein the plurality of frets 42 comprises at least one fret 42′ that has an overall fret length L_{OF} that is less than the width W_{FB} of the fret board 40. In exemplary fret board 40 shown in FIG. 3A, for example, there are ten (10) frets 42′ that have an overall fret length L_{OF} that is less than the width W_{FB} of the fret board 40. Also shown in FIG. 3A, exemplary fret board 40 has four (4) frets that have overall fret lengths L_{OF} equal to the width W_{FB} of the fret board 40. As used herein, the phrase “overall fret length L_{OF}” is used to describe the total length of fret pieces/parts 43 within a given fret 42. See, for example, overall fret length L_{OF} of the bottom fret 42 which equals the sum of distance d_{f1} plus distance d_{f2}.

14. The stringed musical instrument 100 of any one of embodiments 1 to 13, wherein each fret board 40 comprises a plurality of frets 42 extending across a width W_{FB} of the fret board 40 along a length L_{FB} of the fret board 40, wherein the plurality of frets 42 comprises two or more frets 42 that each independently has an overall fret length L_{OF} that is less than the width W_{FB} of the fret board 40.

15. The stringed musical instrument 100 of any one of embodiments 1 to 14, wherein each fret board 40 comprises a plurality of frets 42 extending across a width W_{FB} of the fret board 40 along a length L_{FB} of the fret board 40, wherein the plurality of frets 42 comprises at least one fret 42″ that has an overall fret length L_{OF} that extends from a left-hand edge 44 of the fret board 40 to about a midpoint 45 along the width W_{FB} of the fret board 40. As shown in FIG. 3A, exemplary fret board 40 comprises three (3) frets 42″.

16. The stringed musical instrument 100 of any one of embodiments 1 to 15, wherein each fret board 40 comprises a plurality of frets 42 extending across a width W_{FB} of the fret board 40 along a length L_{FB} of the fret board 40, wherein the plurality of frets 42 comprises at least one fret 42″′ that has an overall fret length L_{OF} that extends from a right-hand edge 46 of the fret board 40 to about a midpoint 45 along the width W_{FB} of the fret board 40. As shown in FIG. 3A, exemplary fret board 40 comprises two (2) frets 42″′.

17. The stringed musical instrument 100 of any one of embodiments 1 to 16, wherein each fret board 40 comprises a plurality of frets 42 extending across a width W_{FB} of the fret board 40 along a length L_{FB} of the fret board 40, wherein the plurality of frets 42 comprises at least one fret 42g that has a fret gap 47 within the fret 42g along the width W_{FB} of t he fret board 40. As shown in FIG. 3A, exemplary fret board 40 comprises three (3) frets 42g.

18. The stringed musical instrument 100 of any one of embodiments 1 to 17, wherein each fret board 40 comprises a plurality of frets 42 extending across a width W_{FB} of the fret board 40 along a length L_{FB} of the fret board 40, wherein the plurality of frets 42 comprises two or more frets 42g that each independently has a fret gap 47 within the fret 42g along the width W_{FB} of the fret board 40. Each fret 42 in the fret board 40 will lie under one, more than one, or all strings 30. There may be more than one fret 42 in a given location on the fret board 40, so that, for example, there may be a fret 42 under one or more strings 30, a fret gap 47 under the next string or strings 30, and a fret 42 again under one or more strings 30.

19. The stringed musical instrument 100 of any one of embodiments 1 to 18, wherein each fret board 40 comprises a plurality of frets 42 extending across a width W_{FB} of the fret board 40 along a length L_{FB} of the fret board 40, wherein the plurality of frets 42 comprises at least one fret 42i that has an overall fret length L_{OF} that is less the width W_{FB} of the fret board 40, and has fret ends 42ₑ₁ and 42ₑ₂ that are independently distanced from a left-hand edge 44 of the fret board 40 and a right-hand edge 46 of the fret board 40. As shown in FIG. 3A, exemplary fret board 40 comprises three (3) frets 42i.

20. The stringed musical instrument 100 of any one of embodiments 1 to 19, wherein each fret board 40 comprises a plurality of frets 42 extending across a width W_{FB} of the fret board 40 along a length L_{FB} of the fret board 40, wherein the plurality of frets 42 comprises two or more frets 42i that each independently has an overall fret length L_{OF} that is less the width W_{FB} of the fret board 40, and each independently has fret ends 42ₑ₁ and 42ₑ₂ that are independently distanced from a left-hand edge 44 of the fret board 40 and a right-hand edge 46 of the fret board 40.

21. The stringed musical instrument 100 of any one of embodiments 1 to 20, wherein each fret board 40 comprises a plurality of frets 42 extending across a width W_{FB} of the fret board 40 along a length L_{FB} of the fret board 40, wherein the plurality of frets 42 comprises at least one fret 42L that has an overall fret length L_{OF} that is substantially equal to the width W_{FB} of the fret board 40. As shown in FIG. 3A, exemplary fret board 40 comprises four (4) frets 42L.

22. The stringed musical instrument 100 of any one of embodiments 1 to 21, wherein each fret board 40 comprises a plurality of frets 42 extending across a width W_{FB} of the fret board 40 along a length L_{FB} of the fret board 40, wherein the plurality of frets 42 comprises two or more frets 42L that each independently has an overall fret length L_{OF} that is substantially equal to the width W_{FB} of the fret board 40.

23. The stringed musical instrument 100 of any one of embodiments 1 to 22, wherein each fret board 40 comprises a plurality of frets 42 extending across a width W_{FB} of the fret board 40 along a length L_{FB} of the fret board 40, wherein the plurality of frets 42 comprises (i) two or more frets 42′ that each independently has an overall fret length L_{OF} that is less than the width W_{FB} of the fret board 40, (ii) at least one fret 42″ that has an overall fret length L_{OF} that extends from a left-hand edge 44 of the fret board 40 to about a midpoint 45 along the width W_{FB} of the fret board 40, (iii) at least one fret 42″′ that has an overall fret length L_{OF} that extends from a right-hand edge 46 of the fret board 40 to about a midpoint 45 along the width W_{FB} of the fret board 40, (iv) two or more frets 42g that each independently has a fret gap 47 within the fret 42g along the width W_{FB} of the fret board 40, (v) at least one fret 42i that has an overall fret length L_{OF} that is less the width W_{FB} of the fret board 40, and has fret ends 42ₑ₁ and 42ₑ₂ that are independently distanced from a left-hand edge 44 of the fret board 40 and a right-hand edge 46 of the fret board 40, (vi) at least one fret 42L that has an overall fret length L_{OF} that is substantially equal to the width W_{FB} of the fret board 40.

24. The stringed musical instrument 100 of any one of embodiments 1 to 23, wherein each fret board 40 is independently attachable to and detachable from the stringed musical instrument 100 along a fret board lodging location 28 between the instrument body string anchor 11 and the neck anchor 21 of the stringed musical instrument 100.

25. The stringed musical instrument 100 of any one of embodiments 1 to 24, wherein each fret board 40 independently comprises one or more fret board connecting members 49 that enable attachment and detachment of the fret board 40 to the stringed musical instrument 100. FIGS. 4A-4D provide a view of possible fret board connecting members 49 including (i) latches/catches/hooks 49′ shown in FIG. 4A, (ii) pegs 49″ shown in FIG. 4B, (iii) locking members 49e shown in FIG. 4C, and (iv) adhesive/hook-loop materials 49a shown in FIG. 4D. As noted above, any fret board connecting member 49 or combination of various fret board connecting members 49 may be used on the fret boards 40 of the present invention.

26. The stringed musical instrument 100 of embodiment 25, wherein the one or more fret board connecting members 49 comprise one or more apertures (not shown) extending through the fret board 40; one or more mechanical connectors 49 extending along a lower surface 401 or upper surface 402 or side edge surface 403 of the fret board 40, the one or more mechanical connectors 49 comprising one or more pegs 49″, hook/loop material 40a, a latching device 49′, one or more locking members 49e, a screw component (not shown), a bolt component (not shown), a loop component (not shown), or any combination thereof; one or more adhesive-type materials 49a that provide a temporary bond; one or more magnets 49a; or any combinations thereof. See again, FIGS. 4A-4D.

27. The stringed musical instrument 100 of any one of embodiments 1 to 26, wherein said stringed musical instrument 100 further comprises one or more stringed musical instrument connecting members 29 that enable attachment and detachment of one or more fret boards 40 to the stringed musical instrument 100. FIGS. 5A-5D provide various views of possible stringed musical instrument connecting members 29 including (i) side holes 29′ shown in FIG. 5A, (ii) top surface holes 29″ shown in FIG. 5B, (iii) stringed musical instrument locking members 29e shown in FIG. 5C, and (iv) adhesive/hook-loop materials/magnets 29a shown in FIG. 5D. As noted above, any stringed musical instrument connecting member 29 or combination of various stringed musical instrument connecting members 29 may be used on the stringed musical instruments 100 of the present invention.

28. The stringed musical instrument 100 of any one of embodiments 1 to 27, wherein said stringed musical instrument 100 further comprises one or more stringed musical instrument connecting members 29 that enable attachment and detachment of one or more fret boards 40 to the stringed musical instrument 100, wherein the one or more stringed musical instrument connecting members 29 are selected from one or more instrument apertures 29/29′/29″ extending into and/or through an upper surface 101 or a lower surface 102 or a side edge surface 103 of the stringed musical instrument 100; one or more mechanical connectors 29 extending along an upper surface 101 or a lower surface 102 or a side edge surface 103 of the stringed musical instrument 100, the one or more mechanical connectors 29 comprising hook/loop material 29a, one or more locking members 29e, a latching device (not shown), a screw component (not shown), a bolt component (not shown), a loop component (not shown), or any combination thereof; one or more adhesive-type materials 29a that provide a temporary bond; one or more magnets 29a; or any combinations thereof.

29. The stringed musical instrument 100 of any one of embodiments 1 to 28, wherein each fret board 40 comprises a fret board 40 with a plurality of frets 42 extending across a width W_{FB} of the fret board 40 along a length L_{FB} of the fret board 40, and the plurality of frets 42 comprise one or more fixed frets 42 at one or more fret locations 422 along the fret board 40. (FIG. 3A). As used herein, the phrase “fixed fret” refers to a fret 42 that is not removable from the fret board 40 (i.e., is permanently attached to fret board 40).

30. The stringed musical instrument 100 of any one of embodiments 1 to 29, wherein each fret board 40 comprises a fret board 40 with a plurality of frets 42 extending across a width W_{FB} of the fret board 40 along a length L_{FB} of the fret board 40, and each fret 42 within the plurality of frets 42 comprises a fixed fret 42 at a fret location 422 along the fret board 40. (FIG. 3A).

31. The stringed musical instrument 100 of any one of embodiments 1 to 29, wherein each fret board 40 comprises a fret board 40 with a plurality of frets 42 extending across at least a portion of a width W_{FB} of the fret board 40 along a length L_{FB} of the fret board 40, and one or more frets 42 within the plurality of frets 42 comprises an attachable/detachable fret 42 that is attachable/detachable at a fret location 422 along the fret board 40. See, for example, FIG. 3B, and 6A-7. The attachable/detachable frets 42 may have detents, nubs or other fret characteristics (e.g., a particular size and shape of a fret connecting member 491 that enables attachment and detachment of the partial fret 43 or attachable/detachable fret 42 to the stringed musical instrument 100) that allow them to (i) latch into a fret board 40 at specific locations (e.g., within fret grooves 424, discussed below) so as to keep the attachable/detachable frets 42 from moving or sliding while in use. A user wanting to play in the key of “C” may (1) select a fret package of attachable/detachable frets 42, and (2) attach the attachable/detachable frets 42 onto a fret board 40, such as a fret board 40 with fret grooves 424 therein. See, for example, exemplary fret 40 with fret grooves 424 shown in FIG. 3B.

32. The stringed musical instrument 100 of embodiment 31, wherein all of the frets 42 within the plurality of frets 42 comprise attachable/detachable frets 42.

33. The stringed musical instrument 100 of any one of embodiments 1 to 32, wherein each fret board 40 comprises a fret board 42 with a plurality of fret grooves 424 extending across a width W_{FB} of the fret board 40 along a length L_{FB} of the fret board 40, wherein the plurality of fret grooves 424 are sized and positioned to receive one or more partial frets 43 or attachable/detachable frets 42 at groove locations 425 along the fret board 40. See again, for example, FIG. 3B, and 6A-7. It should be noted that some fret boards 40 may comprise (1) fixed frets 42, and/or (2)(i) one or more partial frets 43 or attachable/detachable frets 42 in combination with (ii) a plurality of fret grooves 424 into which may be inserted/connected the one or more partial frets 43 or attachable/detachable frets 42. In other fret boards 40, the fret board 40 may comprise only a plurality of fret grooves 424 into which are inserted/connected one or more partial frets 43 or attachable/detachable frets 42 to form a customized fret 42 configuration. As shown in FIG. 3B, each fret groove 424 may have a fret groove length LG that extends the entire width W_{FB} of the fret board 40, or any portion/fraction of the width W_{FB} of the fret board 40. In addition, as shown in FIGS. 6A-6B₄, each fret groove 424 may independently have a fret groove cross-sectional channel configuration that matches a corresponding cross-sectional configuration of a fret connecting member 491 of a given partial fret 43 or attachable/detachable fret 42. See, for example, corresponding cross-sectional configurations of exemplary fret connecting members 491 of exemplary partial frets 43 or attachable/detachable frets 42 shown in FIG. 6C₁-6C₄. Further, there may be multiple fret grooves 424 within a fret location 422 or fret groove location 425. See, for example, the second fret location 422/second fret groove location 425 from the bottom in the exemplary fret board shown in FIG. 3B.

34. The stringed musical instrument 100 of any one of embodiments 1 to 33, wherein each fret board 40 comprises (i) a fret board 40 with a plurality of fret grooves 424 extending across a width W_{FB} of the fret board 40 along a length L_{FB} of the fret board 40, wherein the plurality of fret grooves 424 are sized and positioned to receive one or more partial frets 43 (or attachable/detachable frets 42) at groove locations 425 along the fret board 40 in combination with (ii) one or more partial frets 43 (or attachable/detachable frets 42). (FIG. 3B).

35. The stringed musical instrument 100 of any one of embodiments 1 to 34, wherein each fret board 40 comprises a single fret board 40 (i.e., all frets 42 are positioned along a single fret board 40). (FIG. 3A).

36. The stringed musical instrument 100 of any one of embodiments 1 to 34, wherein each fret board 40 comprises a combination of two more fret board portions 408. FIG. 3C provides a view of such a fret board 40 with 21 separate fret board portions 408. It should be understood that any number of fret board portions 408 could be used to configure a given, customized fret board 40. In addition, it should be understood that each fret board portion 408 may comprise (i) one or more fixed frets 42, (ii) one or more attachable/detachable frets 42, (iii) one or more fret grooves 424, (iii) one or more partial frets 43, (iv) one or more fret board connecting members 49, or (v) any combination of (i), (ii), (iii) and/or (iv).

37. The stringed musical instrument 100 of any one of embodiments 1 to 36, wherein each fret board 40, when attached to the stringed musical instrument 100, becomes at least a portion of an upper layer 110 along the neck 20 of the stringed musical instrument 100.

38. The stringed musical instrument 100 of any one of embodiments 1 to 37, wherein each fret board 40, when attached to the stringed musical instrument 100, becomes a majority (i.e., more than 50%) of an upper layer 110 along the neck 20 of the stringed musical instrument 100.

### Fret Board Embodiments

39. A set of fret boards 40 for a stringed musical instrument 100, said set of fret boards 40 comprising one or more fret boards 40, wherein each fret board 40 has a fret 42 configuration for a specific musical key.

40. The set of fret boards 40 of embodiment 39, wherein the specific musical key is selected from any one of major keys or minor keys or a configuration of scales or other desired configuration.

41. The set of fret boards 40 of embodiment 39 or 40, wherein the specific musical key is selected from the key of “A”, the key of “B”, the key of “C”, the key of “D”, the key of “E”, or the key of “F”.

42. The set of fret boards 40 of embodiment 39 or 40, wherein the specific musical key is selected from the key of “A flat”, the key of “B flat”, the key of “D flat”, the key of “E flat”, the key of “G flat”, the key of “A sharp”, the key of “C sharp”, the key of “D sharp”, the key of “F sharp”, or the key of “G sharp”.

43. The set of fret boards 40 of embodiment 39 or 40, wherein the specific musical key is selected for a specific configuration of scales or other desired configuration.

44. The set of fret boards 40 of any one of embodiments 39 to 43, wherein said set of fret boards 40 comprising one or more fret boards 40.

45. The set of fret boards 40 of any one of embodiments 39 to 44, wherein said set of fret boards 40 comprising a single fret board 40. (FIG. 3A).

46. The set of fret boards 40 of any one of embodiments 39 to 44, wherein said set of fret boards 40 comprising from about three fret boards 40 to about 18 fret boards 40.

47. The set of fret boards 40 of any one of embodiments 39 to 46, wherein each fret board 40 comprises a plurality of frets 42 extending across a width W_{FB} of the fret board 40 along a length L_{FB} of the fret board 40, wherein the plurality of frets 42 comprises at least one fret 42′ that has an overall fret length L_{OF} that is less than the width W_{FB} of the fret board 40.

48. The set of fret boards 40 of any one of embodiments 39 to 47, wherein each fret board 40 comprises a plurality of frets 42 extending across a width W_{FB} of the fret board 40 along a length L_{FB} of the fret board 40, wherein the plurality of frets 42 comprises two or more frets 42′ that each independently has an overall fret length L_{OF} that is less than the width W_{FB} of the fret board 40.

49. The set of fret boards 40 of any one of embodiments 39 to 48, wherein each fret board 40 comprises a plurality of frets 42 extending across a width W_{FB} of the fret board 40 along a length L_{FB} of the fret board 40, wherein the plurality of frets 42 comprises at least one fret 42″ that has an overall fret length L_{OF} that extends from a left-hand edge 44 of the fret board 40 to about a midpoint 45 along the width W_{FB} of the fret board 40.

50. The set of fret boards 40 of any one of embodiments 39 to 49, wherein each fret board 40 comprises a plurality of frets 42 extending across a width W_{FB} of the fret board 40 along a length L_{FB} of the fret board 40, wherein the plurality of frets 42 comprises at least one fret 42″′ that has an overall fret length L_{OF} that extends from a right-ha6d edge 40 of the fret board 40 to about a midpoint 45 along the width W_{FB} of the fret board 40.

51. The set of fret boards 40 of any one of embodiments 39 to 50, wherein each fret board 40 comprises a plurality of frets 42 extending across a width W_{FB} of the fret board 40 along a length L_{FB} of the fret board 40, wherein the plurality of frets 42 comprises at least one fret 42g that has a fret gap 47 within the fret 42g along the width W_{FB} of the fret board 40.

52. The set of fret boards 40 of any one of embodiments 39 to 51, wherein each fret board 40 comprises a plurality of frets 42 extending across a width W_{FB} of the fret board 40 along a length L_{FB} of the fret board 40, wherein the plurality of frets 42 comprises two or more frets 42g that each independently has a fret gap 47 within the fret 42g along the width W_{FB} of the fret board 40.

53. The set of fret boards 40 of any one of embodiments 39 to 52, wherein each fret board 40 comprises a plurality of frets 42 extending across a width W_{FB} of the fret board 40 along a length L_{FB} of the fret board 40, wherein the plurality of frets 42 comprises at least one fret 42i that has an overall fret length L_{OF} that is less the width W_{FB} of the fret board 40, and has fret ends 42ₑ₁ and 42ₑ₂ that are independently distanced from a left-hand edge 44 of the fret board 40 and a right-hand edge 46 of the fret board 40. See again, FIG. 3A.

54. The set of fret boards 40 of any one of embodiments 39 to 53, wherein each fret board 40 comprises a plurality of frets 42 extending across a width W_{FB} of the fret board 40 along a length L_{FB} of the fret board 40, wherein the plurality of frets 42 comprises two or more frets 42i that each independently has an overall fret length L_{OF} that is less the width W_{FB} of the fret board 40, and each independently has fret ends 42ₑ₁ and 42ₑ₂ that are independently distanced from a left-hand edge 44 of the fret board 40 and a right-hand edge 46 of the fret board 40.

55. The set of fret boards 40 of any one of embodiments 39 to 54, wherein each fret board 40 comprises a plurality of frets 42 extending across a width W_{FB} of the fret board 40 along a length L_{FB} of the fret board 40, wherein the plurality of frets 42 comprises at least one fret 42L that has an overall fret length L_{OF} that is substantially equal to the width W_{FB} of the fret board 40.

56. The set of fret boards 40 of any one of embodiments 39 to 55, wherein each fret board 40 comprises a plurality of frets 42 extending across a width W_{FB} of the fret board 40 along a length L_{FB} of the fret board 40, wherein the plurality of frets 42 comprises two or more frets 42L that each independently has an overall fret length L_{OF} that is substantially equal to the width W_{FB} of the fret board 40.

57. The set of fret boards 40 of any one of embodiments 39 to 56, wherein each fret board 40 comprises a plurality of frets 42 extending across a width W_{FB} of the fret board 40 along a length L_{FB} of the fret board 40, wherein the plurality of frets 42 comprises (i) two or more frets 42′ that each independently has an overall fret length L_{OF} that is less than the width W_{FB} of the fret board 40, (ii) at least one fret 42″ that has an overall fret length L_{OF} that extends from a left-hand edge 44 of the fret board 40 to about a midpoint 45 along the width W_{FB} of the fret board 40, (iii) at least one fret 42″′ that has an overall fret length L_{OF} that extends from a right-hand edge 46 of the fret board 40 to about a midpoint 45 along the width W_{FB} of the fret board 40, (iv) two or more frets 42g that each independently has a fret gap 47 within the fret 42g along the width W_{FB} of the fret board 40, (v) at least one fret 42i that has an overall fret length L_{OF} that is less the width W_{FB} of the fret board 40, and has fret ends 42ₑ₁ and 42ₑ₂ that are independently distanced from a left-hand edge 44 of the fret board 40 and a right-hand edge 46 of the fret board 40, (vi) at least one fret 42L that has an overall fret length L_{OF} that is substantially equal to the width W_{FB} of the fret board 40.

58. The set of fret boards 40 of any one of embodiments 39 to 57, wherein each fret board 40 is independently attachable and detachable from the stringed musical instrument 100.

59. The set of fret boards 40 of any one of embodiments 39 to 58, wherein the stringed musical instrument 100 comprises: an instrument body 10; a neck 20 extending from the instrument body 10; strings 30 extending from the instrument body 10, and along the neck 20, each string 30 being connected to (i) an instrument body string anchor 11 and (ii) a neck anchor 21 proximate a neck end 22 opposite the instrument body 10; and wherein each fret board 40 is independently attachable to and detachable from the stringed musical instrument 100 along a fret board lodging location 28 between the instrument body string anchor 11 and the neck anchor 21.

60. The set of fret boards 40 of any one of embodiments 39 to 59, wherein each fret board 40 independently comprises one or more fret board connecting members 49 that enable attachment and detachment of the fret board 40 to the stringed musical instrument 100.

61. The set of fret boards 40 of embodiment 60, wherein the one or more fret board connecting members 49 comprise one or more apertures (not shown) extending through the fret board 40; one or more mechanical connectors 49 extending along a lower surface 401 or upper surface 402 or side edge surface 403 of the fret board 40, the one or more mechanical connectors 49 comprising one or more pegs 49″, hook/loop material 40a, a latching device 49′, one or more locking members 49e, a screw component (not shown), a bolt component (not shown), a loop component (not shown), or any combination thereof; one or more adhesive-type materials 49a that provide a temporary bond; one or more magnets 49a; or any combinations thereof. See again, FIGS. 4A-4D.

62. The set of fret boards 40 of any one of embodiments 39 to 61, wherein each fret board 40 comprises a fret board 40 with a plurality of frets 42 extending across a width W_{FB} of the fret board 40 along a length L_{FB} of the fret board 40, and the plurality of frets 42 comprise one or more fixed frets 42 at one or more fret locations 422 along the fret board 40. (FIG. 3A).

63. The set of fret boards 40 of any one of embodiments 39 to 62, wherein each fret board 40 comprises a fret board 40 with a plurality of frets 42 extending across at least a portion of a width W_{FB} of the fret board 40 along a length L_{FB} of the fret board 40, and one or more frets 42 within the plurality of frets 42 comprises an attachable/detachable fret 42 at a fret location 422 along the fret board 40. (FIG. 3A). The attachable/detachable frets 42 may have detents, nubs or other characteristics that allow them to (i) latch into the fret board 40 at specific locations so as to keep the attachable/detachable frets 42 from moving or sliding while in use. A user wanting to play in the key of “C” may (1) select a fret package of attachable/detachable frets 42, and (2) attach the attachable/detachable frets 42 onto a fret board 40, such as a fret board 40 with fret grooves 424 therein. See, for example, exemplary fret 40 with fret grooves 424 shown in FIG. 3B.

64. The set of fret boards 40 of embodiment 63, wherein all of the frets 42 within the plurality of frets 42 comprise attachable/detachable frets 42.

65. The set of fret boards 40 of any one of embodiments 39 to 64, wherein each fret board 40 comprises a fret board 40 with a plurality of fret grooves 424 extending across a width W_{FB} of the fret board 40 along a length L_{FB} of the fret board 40, wherein the plurality of fret grooves 424 are sized and positioned to receive one or more partial frets 43 (or attachable/detachable frets 42) at groove locations 425 along the fret board 40. (FIG. 3B).

66. The set of fret boards 40 of any one of embodiments 39 to 65, wherein each fret board 40 comprises (i) a fret board 40 with a plurality of fret grooves 424 extending across a width W_{FB} of the fret board 40 along a length L_{FB} of the fret board 40, wherein the plurality of fret grooves 424 are sized and positioned to receive one or more partial frets 43 at groove locations 425 along the fret board 40 in combination with (ii) one or more partial frets 43 (or attachable/detachable frets 42). See again, FIG. 3B.

67. The set of fret boards 40 of any one of embodiments 39 to 66, wherein each fret board 40 comprises a combination of two more fret board portions 408. (FIG. 3C).

68. The set of fret boards 40 of any one of embodiments 39 to 67, wherein each fret board 40, when attached to the stringed musical instrument 100, becomes at least a portion of an upper layer 110 along the neck 20 of the stringed musical instrument 100. See, for example, FIG. 2.

69. The set of fret boards 40 of any one of embodiments 39 to 68, wherein each fret board 40, when attached to the stringed musical instrument 100, becomes a majority (i.e., more than 50%) of an upper layer 110 along the neck 20 of the stringed musical instrument 100.

70. The stringed musical instrument 100 of any one of embodiments 1 to 38, or the set of fret boards 40 of any one of embodiments 39 to 69, wherein the stringed musical instrument 100 comprises a guitar 100, a mandolin (not shown), a ukelele (not shown), or any other stringed musical instrument 100.

### Fret Package Embodiments

71. A set of partial frets 43 or attachable/detachable frets 42, said set of partial frets 43 or attachable/detachable frets 42 (i) being attachable to and detachable from a fret board 40 or a fret board lodging location 28 of a stringed musical instrument 100, and (ii) when assembled on the stringed musical instrument 100, provide a fret 42 configuration for a specific musical key.

72. The set of partial frets 43 or attachable/detachable frets 42 of embodiment 71, wherein the specific musical key is selected from any one of major keys or minor keys or a configuration of scales or other desired configuration.

73. The set of partial frets 43 or attachable/detachable frets 42 of embodiment 71 or 72, wherein the specific musical key is selected from the key of “A”, the key of “B”, the key of “C”, the key of “D”, the key of “E”, or the key of “F”.

74. The set of partial frets 43 or attachable/detachable frets 42 of embodiment 71 or 72, wherein the specific musical key is selected from the key of “A flat”, the key of “B flat”, the key of “D flat”, the key of “E flat”, the key of “G flat”, the key of “A sharp”, the key of “C sharp”, the key of “D sharp”, the key of “F sharp”, or the key of “G sharp”.

75. The set of partial frets 43 or attachable/detachable frets 42 of embodiment 71 or 72, wherein the specific musical key is selected for a specific configuration of scales or, other desired configuration.

76. The set of partial frets 43 or attachable/detachable frets 42 of any one of embodiments 71 to 75, wherein said set comprises from two to 24 partial frets 43 or attachable/detachable frets 42.

77. The set of partial frets 43 or attachable/detachable frets 42 of any one of embodiments 71 to 76, wherein said set comprises from 12 to 18 partial frets 43 or attachable/detachable frets 42. It should be understood that a given set of partial frets 43 or attachable/detachable frets 42 can have any number of partial frets 43 or attachable/detachable frets 42 therein.

78. The set of partial frets 43 or attachable/detachable frets 42 of any one of embodiments 71 to 77, wherein the set of partial frets 43 or attachable/detachable frets 42 comprises at least one attachable/detachable fret 42′ that has an overall fret length L_{OF} that is less than the width W_{FB} of the fret board 40.

79. The set of partial frets 43 or attachable/detachable frets 42 of any one of embodiments 71 to 78, wherein the set of partial frets 43 or attachable/detachable frets 42 comprises two or more attachable/detachable frets 42′ that each independently has an overall fret length L_{OF} that is less than the width W_{FB} of the fret board 40.

80. The set of partial frets 43 or attachable/detachable frets 42 of any one of embodiments 71 to 79, wherein the set of partial frets 43 or attachable/detachable frets 42 comprises at least one attachable/detachable fret 42″ that has an overall fret length L_{OF} that extends from a left-hand edge 44 of the fret board 40 to about a midpoint 45 along the width W_{FB} of the fret board 40.

81. The set of partial frets 43 or attachable/detachable frets 42 of any one of embodiments 71 to 80, wherein the set of partial frets 43 or attachable/detachable frets 42 comprises at least one attachable/detachable fret 42″′ that has an overall fret length L_{OF} that extends from a right-hand edge 40 of the fret board 40 to about a midpoint 45 along the width W_{FB} of the fret board 40.

82. The set of partial frets 43 or attachable/detachable frets 42 of any one of embodiments 71 to 81, wherein the set of partial frets 43 or attachable/detachable frets 42 comprises at least one attachable/detachable fret 42g that has a fret gap 47 within the attachable/detachable fret 42g along the width W_{FB} of the fret board 40.

83. The set of partial frets 43 or attachable/detachable frets 42 of any one of embodiments 71 to 82, wherein the set of partial frets 43 or attachable/detachable frets 42 comprises two or more attachable/detachable frets 42g that each independently has a fret gap 47 within the attachable/detachable fret 42g along the width W_{FB} of the fret board 40.

84. The set of partial frets 43 or attachable/detachable frets 42 of any one of embodiments 71 to 83, wherein the set of partial frets 43 or attachable/detachable frets 42 comprises at least one attachable/detachable fret 42i that has an overall fret length L_{OF} that is less the width W_{FB} of the fret board 40, and has fret ends 42ₑ₁ and 42ₑ₂ that are independently distanced from a left-hand edge 44 of the fret board 40 and a right-hand edge 46 of the fret board 40. See again, FIG. 3A.

85. The set of partial frets 43 or attachable/detachable frets 42 of any one of embodiments 71 to 84, wherein the set of partial frets 43 or attachable/detachable frets 42 comprises two or more attachable/detachable frets 42i that each independently has an overall fret length L_{OF} that is less the width W_{FB} of the fret board 40, and each independently has fret ends 42ₑ₁ and 42ₑ₂ that are independently distanced from a left-hand edge 44 of the fret board 40 and a right-hand edge 46 of the fret board 40.

86. The set of partial frets 43 or attachable/detachable frets 42 of any one of embodiments 71 to 85, wherein the set of partial frets 43 or attachable/detachable frets 42 comprises at least one attachable/detachable fret 42L that has an overall fret length L_{OF} that is substantially equal to the width W_{FB} of the fret board 40.

87. The set of partial frets 43 or attachable/detachable frets 42 of any one of embodiments 71 to 86, wherein the set of partial frets 43 or attachable/detachable frets 42 comprises two or more attachable/detachable frets 42L that each independently has an overall fret length L_{OF} that is substantially equal to the width W_{FB} of the fret board 40.

88. The set of partial frets 43 or attachable/detachable frets 42 of any one of embodiments 71 to 87, wherein the set of partial frets 43 or attachable/detachable frets 42 comprises (i) two or more attachable/detachable frets 42′ that each independently has an overall fret length L_{OF} that is less than the width W_{FB} of the fret board 40, (ii) at least one attachable/detachable fret 42″ that has an overall fret length L_{OF} that extends from a left-hand edge 44 of the fret board 40 to about a midpoint 45 along the width W_{FB} of the fret board 40, (iii) at least one attachable/detachable fret 42″′ that has an overall fret length L_{OF} that extends from a right-hand edge 46 of the fret board 40 to about a midpoint 45 along the width W_{FB} of the fret board 40, (iv) two or more attachable/detachable frets 42g that each independently has a fret gap 47 within the fret 42g along the width W_{FB} of the fret board 40, (v) at least one attachable/detachable fret 42i that has an overall fret length L_{OF} that is less the width W_{FB} of the fret board 40, and has fret ends 42ₑ₁ and 42ₑ₂ that are independently distanced from a left-hand edge 44 of the fret board 40 and a right-hand edge 46 of the fret board 40, (vi) at least one attachable/detachable fret 42L that has an overall fret length L_{OF} that is substantially equal to the width W_{FB} of the fret board 40.

89. The set of partial frets 43 or attachable/detachable frets 42 of any one of embodiments 71 to 88, in combination with the stringed musical instrument 100.

90. The set of partial frets 43 or attachable/detachable frets 42 of any one of embodiments 71 to 89, wherein the stringed musical instrument 100 comprises: an instrument body 10; a neck 20 extending from the instrument body 10; strings 30 extending from the instrument body 10, and along the neck 20, each string 30 being connected to (i) an instrument body string anchor 11 and (ii) a neck anchor 21 proximate a neck end 22 opposite the instrument body 10; and the fret board 40 or the fret board lodging location 28 is between the instrument body string anchor 11 and the neck anchor 21.

91. The set of partial frets 43 or attachable/detachable frets 42 of any one of embodiments 71 to 90, wherein each partial fret 43 or attachable/detachable fret 42 independently comprises one or more fret connecting members 491 that enable attachment and detachment of the partial fret 43 or attachable/detachable fret 42 to the stringed musical instrument 100. See, for example, FIGS. 6A-7.

92. The set of partial frets 43 or attachable/detachable frets 42 of any one of embodiments 71 to 91, wherein each partial fret 43 or attachable/detachable fret 42 independently comprises a single fret connecting member 491 that enables attachment and detachment of the partial fret 43 or attachable/detachable fret 42 to the stringed musical instrument 100.

93. The set of partial frets 43 or attachable/detachable frets 42 of embodiment 91 or 92, wherein each fret connecting member 491 comprises a fret connecting member 491 extending along a lower surface 427 of the partial fret 43 or attachable/detachable fret 42.

94. The set of partial frets 43 or attachable/detachable frets 42 of any one of embodiments 91 to 93, wherein each fret connecting member 491 comprises a fret connecting member 491 extending along and an integrally connected to a lower surface 427 of the partial fret 43 or attachable/detachable fret 42. See, for example, exemplary fret 42 shown in FIGS. 6A-7.

95. The set of partial frets 43 or attachable/detachable frets 42 of any one of embodiments 91 to 94, wherein each fret connecting member 491 independently has a fret connecting member cross-sectional configuration that enables a given partial fret 43 or attachable/detachable fret 42 to be attached to and detachable from a corresponding fret groove 424 cross-sectional channel configuration. See again, for example, cross-sectional configurations of exemplary fret connecting members 491 of exemplary partial frets 43 or attachable/detachable frets 42 shown in FIG. 6C₁-6C₄, and corresponding fret groove 424 cross-sectional channel configurations shown in FIG. 6B₁-6B₄ and FIG. 6C₁-6C₄.

It should be understood that the set of partial frets 43 or attachable/detachable frets 42 of the present invention may comprise other features that enable attachment and detachment of a given partial fret 43 or attachable/detachable fret 42 to a fret board 40 or fret board portion 408. Other connecting features could include, but are not limited to, the one or more mechanical connectors comprising one or more pegs (not shown), hook/loop material (not shown), a latching device (not shown), one or more locking members (not shown), a screw component (not shown), a bolt component (not shown), a loop component (not shown), or any combination thereof; one or more adhesive-type materials (not shown) that provide a temporary bond; one or more magnets (not shown); or any combinations thereof.

### Methods of Making Stringed Musical Instruments Embodiments

96. A method for making the string musical instrument 100 of any one of embodiments 1 to 38, said method comprising: (a) forming the instrument body 10 with (i) the neck 20 extending from the instrument body 10, (ii) an instrument body string anchor 11 proximate one end 23 of the instrument body 10 opposite the neck 20, and (iii) a neck anchor 21 proximate a neck end 22 opposite the instrument body 10; and (b) forming the one or more fret boards 40, each fret board 40 being attachable to and detachable from the neck 20 of the stringed musical instrument 100.

97. A method for making the string musical instrument 100 of any one of embodiments 1 to 38, said method comprising: (a) forming the instrument body 10 with (i) the neck 20 extending from the instrument body 10, (ii) an instrument body string anchor 11 proximate one end 23 of the instrument body 10 opposite the neck 20, and (iii) a neck anchor 21 proximate a neck end 22 opposite the instrument body 10; and (b) forming a fret board 40 that has a fret 42 configuration along the fret board 40 for a specific musical key.

98. The method of embodiment 97, wherein the fret board 40 is an integral component of the string musical instrument 100 (i.e., the fret board 40 is not removable from the string musical instrument 100).

99. The method of embodiment 97, wherein the fret board 40 is attachable to and detachable from the neck 20 of the stringed musical instrument 100.

### Methods of Making Fret Boards Embodiments

100. A method for making the set of fret boards 40 of any one of embodiments 39 to 69, said method comprising: forming a fret board 40 that has a fret 42 configuration for a specific musical key. For example, the fret board 40 has frets 42 such that all notes and chords played on the stringed musical instrument 100 are within the same key, e.g., the key of “C”.

101. The method of embodiment 100, wherein said forming step comprises forming two or more fret boards 40, with each fret board 40 independently having a fret 42 configuration for a specific musical key (i.e., the same key or two different keys).

102. The method of embodiment 100 or 101, wherein said forming step further comprises: forming one or more stringed musical instrument connecting members 29 that enable attachment and detachment of the one or more fret boards 40 to a stringed musical instrument 100, wherein the one or more stringed musical instrument connecting members 29 are selected from one or more instrument apertures 29/29′/29″ extending into and/or through an upper surface 101 or a lower surface 102 or a side edge surface 103 of the stringed musical instrument 100; one or more mechanical connectors 29 extending along an upper surface 101 or a lower surface 102 or a side edge surface 103 of the stringed musical instrument 100, the one or more mechanical connectors 29 comprising hook/loop material 29a, one or more locking members 29e, a latching device (not shown), a screw component (not shown), a bolt component (not shown), a loop component (not shown), or any combination thereof; one or more adhesive-type materials 29a that provide a temporary bond; one or more magnets 29a; or any combinations thereof.

### Methods of Making Frets Embodiments

103. A method for making the set of partial frets 43 or attachable/detachable frets 42 of any one of embodiments 71 to 95, said method comprising: forming one or more partial frets 43 and/or attachable/detachable frets 42 with each partial fret 43 or attachable/detachable fret 42 (i) being attachable to and detachable from a fret board 40 or a fret board lodging location 28 of a stringed musical instrument 100, and (ii) when assembled on the stringed musical instrument 100, provide a fret 42 configuration for a specific musical key.

104. The method of embodiment 103, wherein said forming step further comprises: forming one or more fret connecting members 491 along a lower surface 427 of the partial fret 43 or attachable/detachable fret 42, the one or more fret connecting members 491 enabling attachment and detachment of the partial fret 43 or attachable/detachable fret 42 to the stringed musical instrument 100).

105. The method of any one of embodiments 96 to 104, wherein said forming step comprises one or more of: cutting material, shaping material, finishing (e.g., painting, polishing, etc.) material, assembling materials with one another, a molding step, an extruding step, or any combination thereof.

### Methods of Using Stringed Musical Instruments, Frets, and Fret Boards Embodiments

106. A method for enabling the attachment/removal of various length frets 42 within a fret board 40 that allows the frets 42 to be securely placed by the user where desired along the fret board 40. As discussed above, this includes locking mechanisms such as nubs, detents, springs, or other methods on the frets 42 and a reciprocating component on the fret board 40 allowing the frets 42 to lock-in to specific positions on the fret board 40.

107. A method of playing a stringed musical instrument 100 in a particular musical key, said method comprising: attaching one or more attachable/detachable frets 42 to the stringed musical instrument 100.

108. A method of playing a stringed musical instrument 100 in a particular musical key, said method comprising: attaching one or more attachable/detachable fret boards 40 to the stringed musical instrument 100.

109. A method of playing a stringed musical instrument 100 in a particular musical key, said method comprising: attaching one or more attachable/detachable frets 42 to one or more fret boards 40 of the stringed musical instrument 100; and attaching the one or more fret boards 40 to the stringed musical instrument 100.

### EXAMPLES

Stringed musical instruments, frets, and fret boards, as shown in FIGS. 1-7, and described above and in embodiments 1 to 95, were formed, and used to produce string music.

It should be understood that although the above-described stringed musical instruments, sets of fret boards for a stringed musical instrument, sets of partial frets and/or attachable/detachable frets for a stringed musical instrument, and/or methods are described as “comprising” one or more components or steps, the above-described stringed musical instruments, sets of fret boards for a stringed musical instrument, sets of partial frets and/or attachable/detachable frets for a stringed musical instrument, and/or methods may “comprise,” “consists of,” or “consist essentially of” any of the above-described components, features, or steps of the stringed musical instruments, sets of fret boards for a stringed musical instrument, sets of partial frets and/or attachable/detachable frets for a stringed musical instrument, and/or methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains,” “containing,” “characterized by” or any other variation thereof, are intended to encompass a non-exclusive inclusion, subject to any limitation explicitly indicated otherwise, of the recited components. For example, a stringed musical instrument, set of fret boards for a stringed musical instrument, set of partial frets and/or attachable/detachable frets for a stringed musical instrument, and/or method that “comprises” a list of elements (e.g., components, features, or steps) is not necessarily limited to only those elements (or components or steps), but may include other elements (or components or steps) not expressly listed or inherent to the stringed musical instrument, the set of fret boards for a stringed musical instrument, the set of partial frets and/or attachable/detachable frets for a stringed musical instrument, and/or the method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a stringed musical instrument, set of fret boards for a stringed musical instrument, sets of partial frets and/or attachable/detachable frets for a stringed musical instrument, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of.”

Further, it should be understood that the herein-described stringed musical instruments, sets of fret boards for a stringed musical instrument, sets of partial frets and/or attachable/detachable frets for a stringed musical instrument, and/or methods may comprise, consist essentially of, or consist of any of the herein-described components and features, with or without any additional feature(s). In other words, in some embodiments, the stringed musical instruments, sets of fret boards for a stringed musical instrument, sets of partial frets and/or attachable/detachable frets for a stringed musical instrument, and/or methods of the present invention do not have any additional features other than those described herein, and such additional features, not described herein, are specifically excluded from the stringed musical instruments, sets of fret boards for a stringed musical instrument, sets of partial frets and/or attachable/detachable frets for a stringed musical instrument, and/or methods. In other embodiments, the stringed musical instruments, sets of fret boards for a stringed musical instrument, sets of partial frets and/or attachable/detachable frets for a stringed musical instrument, and/or methods of the present invention do have one or more additional features that are not described herein.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A stringed musical instrument comprising:
an instrument body;
a neck extending from the instrument body;
strings extending from the instrument body, and along the neck, each string being connected to (i) an instrument body string anchor and (ii) a neck anchor proximate a neck end opposite the instrument body; and
one or more fret boards, each fret board being attachable to and detachable from the neck of the stringed musical instrument.

2. The stringed musical instrument of claim 1, wherein each fret board has a fret configuration for a specific musical key, or a set of scales, or other desired configuration.

3. A stringed musical instrument comprising:
an instrument body;
a neck extending from the instrument body;
strings extending from the instrument body, and along the neck, each string being connected to (i) an instrument body string anchor and (ii) a neck anchor proximate a neck end opposite the instrument body; and
a fret board along the neck of the stringed musical instrument, the fret board having a fret configuration for a specific musical key.

4. The stringed musical instrument of claim 3, wherein the fret board is attached to and not removable from the neck of the stringed musical instrument.

5. The stringed musical instrument of claim 3, wherein the fret board is attachable to and detachable from the neck of the stringed musical instrument.

6. The stringed musical instrument of claim 5, wherein the fret board is one fret board within a set of one or more fret boards, each fret board being attachable to and detachable from the neck of the stringed musical instrument.

7. The stringed musical instrument of claim 6, wherein each fret board has a fret configuration for a specific musical key, and the specific musical key is selected from any one of major keys or minor keys or configuration of scales.

8. The stringed musical instrument of claim 6, wherein the specific musical key is selected from the key of “A”, the key of “B”, the key of “C”, the key of “D”, the key of “E”, the key of “F”, the key of “A flat”, the key of “B flat”, the key of “D flat”, the key of “E flat”, the key of “G flat”, the key of “A sharp”, the key of “C sharp”, the key of “D sharp”, the key of “F sharp”, or the key of “G sharp”.

9. The stringed musical instrument of claim 1, wherein said one or more fret boards comprises two or more fret boards.

10. The stringed musical instrument of claim 9, wherein said two or more fret boards comprises from about three fret boards to about 18 fret boards.

11. The stringed musical instrument of claim 5, wherein each fret board comprises a plurality of frets extending across at least a portion of a width W_{FB} of the fret board along a length L_{FB} of the fret board, wherein the plurality of frets comprises (i) at least one fret that has an overall fret length L_{OF} that is less than the width W_{FB} of the fret board, (ii) at least one fret that has an overall fret length L_{OF} that extends from a left-hand edge of the fret board to about a midpoint along the width W_{FB} of the fret board, (iii) at least one fret that has an overall fret length L_{OF} that extends from a right-hand edge of the fret board to about a midpoint along the width W_{FB} of the fret board, (iv) at least one fret that has a fret gap within the fret along the width W_{FB} of the fret board, (v) at least one fret that has an overall fret length L_{OF} that is less the width W_{FB} of the fret board, and has fret ends that are independently distanced from a left-hand edge of the fret board and a right-hand edge of the fret board, (vi) at least one fret that has an overall fret length L_{OF} that is substantially equal to the width W_{FB} of the fret board, or (vii) any combination of (i) to (vi).

12. The stringed musical instrument of claim 1, wherein each fret board is independently attachable to and detachable from the stringed musical instrument along a fret board lodging location between the instrument body string anchor and the neck anchor of the stringed musical instrument.

13. The stringed musical instrument of claim 12, wherein each fret board independently comprises one or more connecting members that enable attachment and detachment of the fret board to the stringed musical instrument.

14. The stringed musical instrument of claim 13, wherein said stringed musical instrument further comprises one or more stringed musical instrument connecting members that enable attachment and detachment of one or more fret boards to the stringed musical instrument.

15. The stringed musical instrument of claim 1, wherein each fret board comprises a plurality of frets extending across at least a portion of a width W_{FB} of the fret board along a length L_{FB} of the fret board, wherein the plurality of frets comprises at least one attachable/detachable fret that has an overall fret length L_{OF} that is less than or equal to the width W_{FB} of the fret board.

16. The stringed musical instrument of claim 3, wherein the fret board comprises a plurality of frets extending across at least a portion of a width W_{FB} of the fret board along a length L_{FB} of the fret board, wherein the plurality of frets comprises at least one attachable/detachable fret that has an overall fret length L_{OF} that is less than or equal to the width W_{FB} of the fret board.

17. A set of fret boards for the stringed musical instrument of claim 1, said set of fret boards comprising one or more fret boards, wherein each fret board (a) has a fret configuration for a specific musical key, and (b) is attachable to and detachable from a neck of the stringed musical instrument.

18. The set of fret boards of claim 17, wherein the specific musical key is selected from the key of “A”, the key of “B”, the key of “C”, the key of “D”, the key of “E”, or the key of “F”, the key of “A flat”, the key of “B flat”, the key of “D flat”, the key of “E flat”, the key of “G flat”, the key of “A sharp”, the key of “C sharp”, the key of “D sharp”, the key of “F sharp”, or the key of “G sharp”.

19. A set of partial frets or attachable/detachable frets for the stringed musical instrument of claim 3, said set of partial frets or attachable/detachable frets (i) being attachable to and detachable from a fret board or a fret board lodging location of the stringed musical instrument, and (ii) when assembled on the stringed musical instrument, provide a fret configuration for a specific musical key.

20. The set of partial frets or attachable/detachable frets of claim 19, wherein the specific musical key is selected from the key of “A”, the key of “B”, the key of “C”, the key of “D”, the key of “E”, or the key of “F”, the key of “A flat”, the key of “B flat”, the key of “D flat”, the key of “E flat”, the key of “G flat”, the key of “A sharp”, the key of “C sharp”, the key of “D sharp”, the key of “F sharp”, or the key of “G sharp”.
